(19) United States
(12) Patent Application Publication
(10) Pub. No.: US 2013/0298053 A1
(43) Pub. Date: Nov. 7, 2013

(54) SCOREBOARD MODELING

(71) Applicants: Jon Sprang, Brookings, SD (US); Josh Spahr, Brookings, SD (US); Angela Hatton, Brookings, SD (US); Eric Bauer, Volga, SD (US)

(72) Inventors: Jon Sprang, Brookings, SD (US); Josh Spahr, Brookings, SD (US); Angela Hatton, Brookings, SD (US); Eric Bauer, Volga, SD (US)

(21) Appl. No.: 13/795,332

(22) Filed: Mar. 12, 2013

Related U.S. Application Data
(60) Provisional application No. 61/642,960, filed on May 4, 2012.

(51) Int. Cl. G06F 3/0484

(52) U.S. Cl. CPC G06F 3/0484
USPC 715/765

(57) ABSTRACT

Various embodiments illustrated and described herein include at least one of systems, methods, and software to generate one or both of scoreboard illustrations and functional and renderable scoreboard animation via scoreboard modeling. The various embodiments illustrated and described herein may operate on single, stand-alone computing devices, as network or “cloud”-based solutions accessible via a network such as the Internet, or a mixture of both.

### RELATED APPLICATION

This application is related and claims priority to U.S. Provisional Application Ser. No. 61/642,960, filed on May 4, 2012, and entitled SCOREBOARD MODELING, the entirety of which is incorporated herein by reference.

### BACKGROUND INFORMATION

Scoreboards can be customized by altering many variables. To date, to generate a mockup of how a scoreboard may appear, manual illustration, either via pen-and-paper-type illustration or computer-graphic-type illustration, has been required. Further, if an illustration is not acceptable, further manual illustration is required to correct the illustration. This can be a time consuming and expensive process.

Further, scoreboards today are generally fixed as far as scoreboard components are concerned. Such fixed scoreboard components, for example, include a timer, timeout indicators, score elements for each teach or individual competing in an event, and the like. Such elements are fixed in the sense that they exist and cannot have their locations modified and the element cannot be removed once installed.

### BRIEF DESCRIPTION OF THE DRAWINGS

FIG. 1 is a user interface illustration, according to an example embodiment.

FIG. 2 is a user interface illustration, according to an example embodiment.

FIG. 3 is a user interface illustration, according to an example embodiment.

FIG. 4 is a user interface illustration, according to an example embodiment.

FIG. 5 is a user interface illustration, according to an example embodiment.

FIG. 6 is a user interface illustration, according to an example embodiment.

FIG. 7 is a user interface illustration, according to an example embodiment.

FIG. 8 is a user interface illustration, according to an example embodiment.

FIG. 9 is a user interface illustration, according to an example embodiment.

FIG. 10 is a user interface illustration, according to an example embodiment.

FIG. 11 is a user interface illustration, according to an example embodiment.

FIG. 12 is a user interface illustration, according to an example embodiment.

FIG. 13 is a logical block diagram of a method, according to an example embodiment.

FIG. 14 is a block diagram of a system, according to an example embodiment.

FIG. 15 is a block diagram of a computing device, according to an example embodiment.

### DETAILED DESCRIPTION

Various embodiments illustrated and described herein include at least one of systems, methods, and software to generate one or both of scoreboard illustrations and functional and renderable scoreboard animation via scoreboard modeling. Such scoreboard illustrations may be utilized in multiple contexts. These contexts may include scoreboard sales to generate a mockup of how a scoreboard may look according to customer selections received as input. Other contexts may include generating a sales quote based on the customer preferences, generating a graphical output such as a sales brochure or an image file that may be utilized in a computer aided drafting (CAD) mockup of a facility, and the like. The output of some embodiments may also, or alternatively, be a scoreboard visualization application that may execute on a computing device to generate graphical output for presentation via a display device, such as one or more of a video monitor, a video projector, within a web page, and the like. Further detail with regard to these embodiments, and others, are provided herein.

Although the term scoreboard is used throughout the description, the various embodiments may also be utilized in non-scoreboard contexts, as will be readily apparent. For example, the contexts may include modeling of business signage, roadside signage as may be utilized along toll ways with regard to variable tolls, to alert drivers to upcoming hazards, upcoming scheduled construction, parking information, and other electronic signage contexts.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

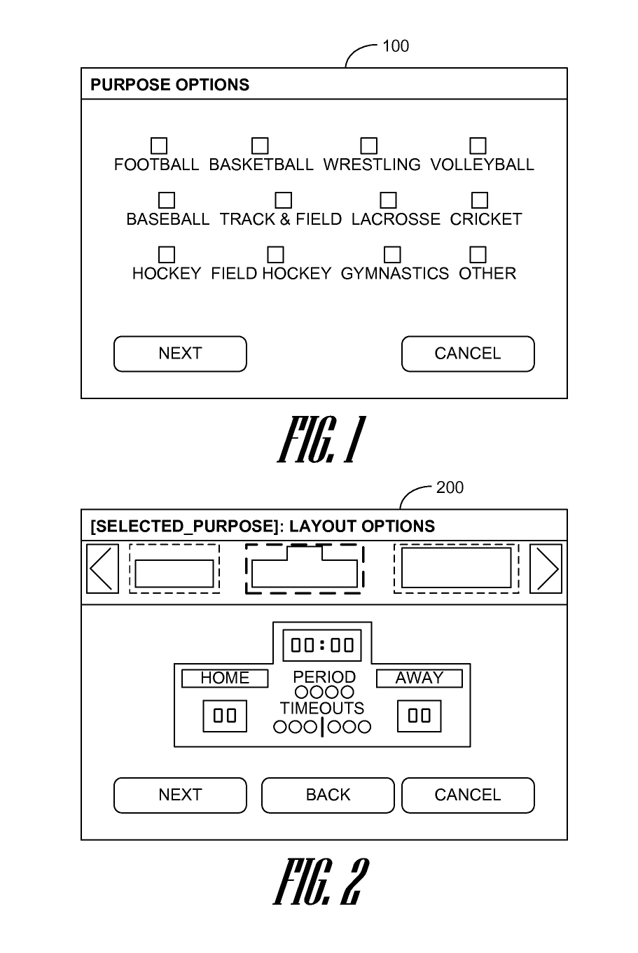

FIG. 1 through FIG. 12 provide user interface illustrations of a wizard-like program that takes a user through a systemic, sometimes step-by-step, process to input scoreboard specifications. The systemic process provided through the user interfaces of FIG. 1 through FIG. 12 correspond to different options associated with scoreboard design. As such, the number and the actual options may vary between embodiments based on different scoreboard options that may be available at any given time from one or more scoreboard manufacturers for which the particular embodiment may be generated. Further, the user interfaces of FIG. 1 through FIG. 12 are intended to illustrate examples of how such user interfaces may be provided in some embodiments. However, the user interfaces may vary in both content and number. Further, the user interfaces of FIG. 1 through FIG. 12, as illustrated, are intended to reflect user interfaces that may be presented via web pages or a rich Internet application accessible over a network, such as the Internet. However, some other embodiments may deliver user interfaces of the particular embodiment via a standalone application that executes on a personal computer, via an app that executes on a smartphone, tablet, within a web browser, or other device or application within which an app may execute.

The options presented via the user interfaces of FIG. 1 through FIG. 12 may vary based on selected options. For example, if a selection is made specifying a scoreboard being modeled is intended for use with a particular sport, certain options that may be sport-specific for a different sport are not presented in some embodiments. Thus, the systematic process a user is guided through via the user interfaces may be adaptable in some embodiments to request only relevant input.

FIG. 1 is a user interface 100 illustration, according to an example embodiment. The user interface 100 provides options to designate the purpose for a scoreboard that is to be modeled. Typically, the purpose of the scoreboard will be for one or more sports, as indicated in the example user interface 100. However, other purposes and multiple purposes may be provided as options and selected. For example, a scoreboard intended to be placed in a gymnasium for use with multiple sports, such as basketball, volleyball, and wrestling. Once one or more purposes are selected, a NEXT button may be selected to via a next set of options.

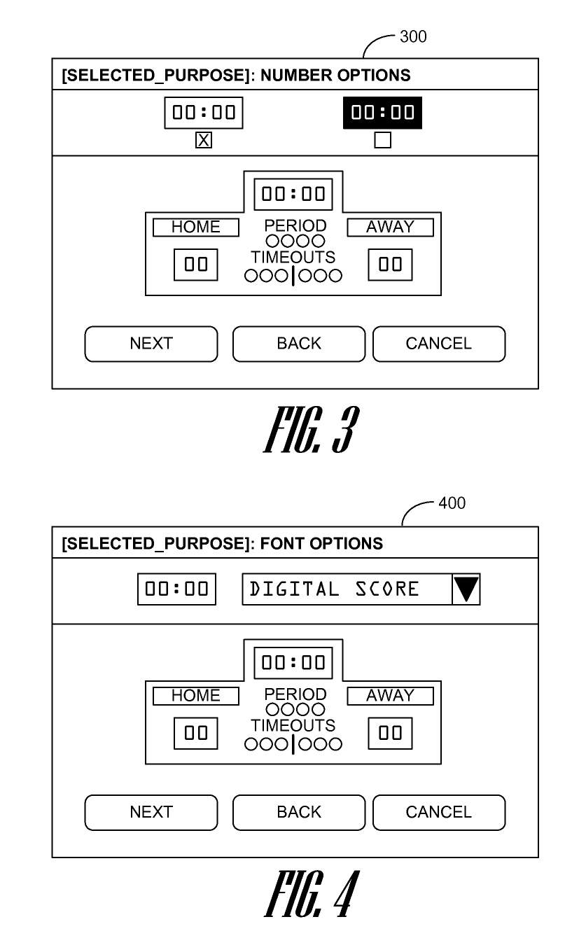

FIG. 2 is a user interface 200 illustration, according to an example embodiment. The user interface 200 is an example of a user interface to provide users with scoreboard layout options. The example embodiments as illustrated in FIG. 2 through FIG. 12 are based on an assumed selection of BASKETBALL in the user interface 100 of FIG. 1. The layout options presented within the user interface 200 therefore are with regard to scoreboard layouts that are in a basketball context. The user selects a layout option from a set of one or more different options that may be available and a larger view of the selected scoreboard layout is presented. The scoreboard layout presented in the larger view is based on one or more stored image files, such as may be stored in a database or on a file server accessible to an application server that provides the web page of providing the user interface 200. The one or more images are presented throughout the user interfaces of FIG. 2 through FIG. 12 and are modified as a user provides input specifying which options to include in the modeled scoreboard. The view of the scoreboard may be modified through one or more of layering of one or more images at particular points in the scoreboard view, changing properties of image elements such as colors, fonts, and sizes, among other possible modification. Once the user has selected a layout option, the NEXT button may be selected and the user interface 300 of FIG. 3 may be presented.

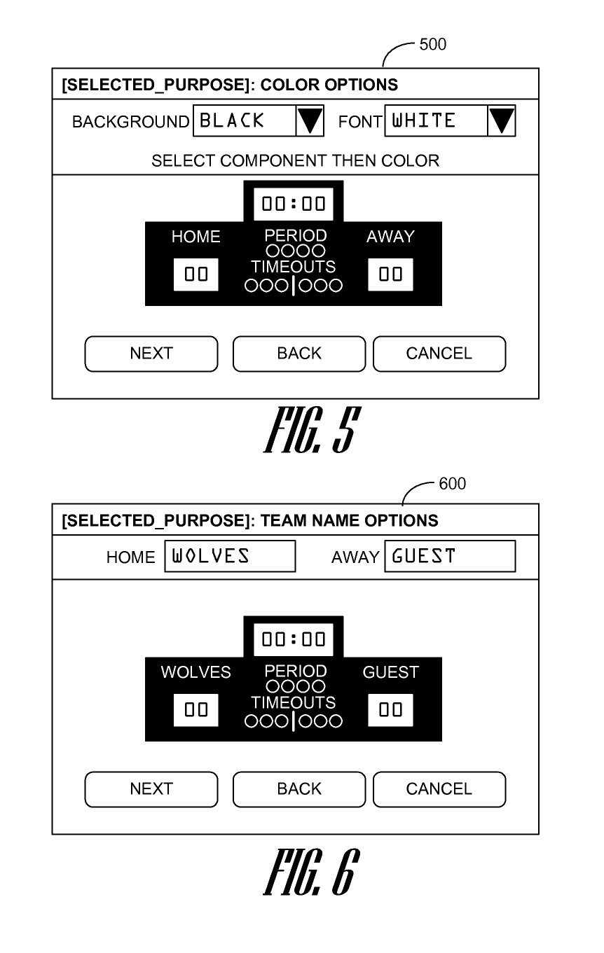

FIG. 3 is a user interface 300 illustration, according to an example embodiment. The user interface 300 provides options with regard to how numbers and digital text are output by the scoreboard. There are different ways in which numbers and text may be output digitally via scoreboards through use of light emitting diode types and arrangements and the user interface 300 provides such options. Once the user has selected a digital text option, the NEXT button may be selected and the user interface 400 of FIG. 4 may be presented.

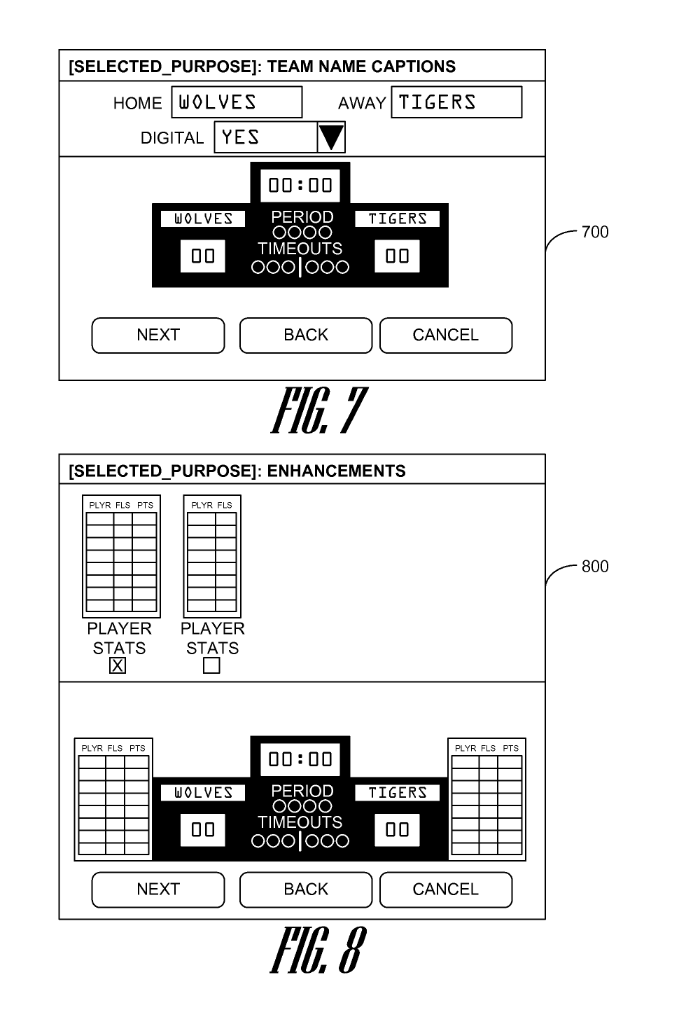

FIG. 4 is a user interface 400 illustration, according to an example embodiment. The user interface presents font options for text and numbers presented digitally by the scoreboard. Once the user has selected a font option, the NEXT button may be selected and the user interface 500 of FIG. 5 may be presented.

FIG. 5 is a user interface 500 illustration, according to an example embodiment. This user interface 500 provides color options with regard to a scoreboard background and font colors that are presented on the face of the scoreboard. As illustrated, input is received specifying the background is to be BLACK and the text is to be WHITE. These selections are then reflected in the presented scoreboard view as illustrated within the user interface 500. Once the user has selected color options, the NEXT button may be selected and the user interface 600 of FIG. 6 may be presented.

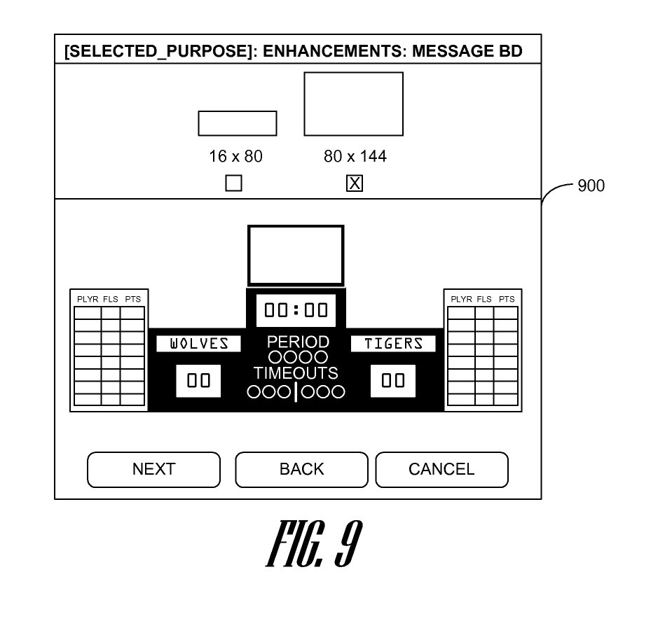

FIG. 6 is a user interface 600 illustration, according to an example embodiment. The user interface of FIG. 6 provides user interface controls within which team names may be input as text. For example, and as illustrated, the home team name is input as WOLVES and the away team name is input as GUEST. FIG. 7 provides an alternate embodiment of such a user interface 600 where team names may be input.

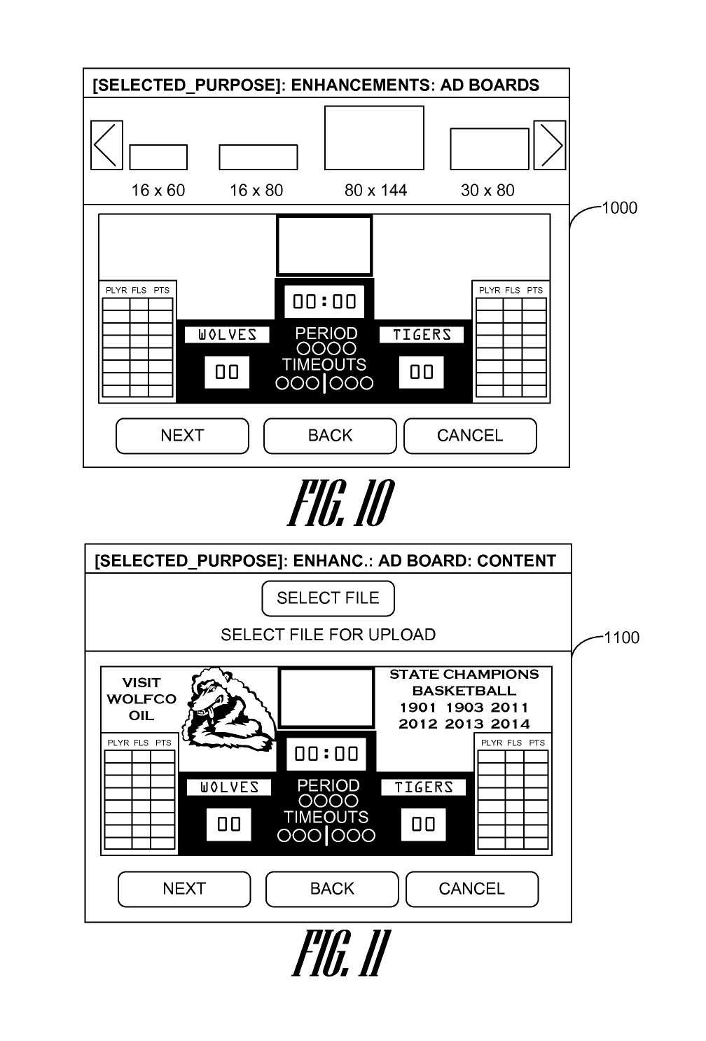

FIG. 7 is a user interface 700 illustration, according to an example embodiment. The user interface 700 provides an additional option where an option is presented to have the team names presented digitally. This option provides digital text fields on the scoreboard that can be modified to the specific teams that are playing. The team names may then be input and the input names will be reflected in the modeled scoreboard view. Once the user specified the team names in either of user interface 600 of FIG. 6 or user interface 700 of FIG. 7, the NEXT button may be selected and the user interface 800 of FIG. 8 may be presented.

FIG. 8 is a user interface 800 illustration, according to an example embodiment. The user interface 800 is an example of a set of options that are specific to an earlier selected option. Here, the user interface 800 presents an option that is basketball specific due to the earlier purpose option selection in the user interface 100 of FIG. 1. The option presented in the user interface 800 may be referred to as an enhancement option. Enhancement options are add-ons to a scoreboard that increase the functionality of the scoreboard or otherwise allow the scoreboard to present additional information, whether that information be dynamic to changing game conditions or other content, such as advertisements or messages for the audience. The specific options presented in the user interface 800 are with regard to basketball player numbers, numbers of fouls, and a number of points scored. While enhancement options are presented, there is no requirement that any particular enhancement option be selected in typical embodiments. However, in the illustrated embodiment, a player stats enhancement option is selected and the modeled scoreboard view is modified to reflect the selection. Once the user specified the options for the user interface 800, the NEXT button may be selected and the user interface 900 of FIG. 9 may be presented.

FIG. 9 is a user interface 900 illustration, according to an example embodiment. The user interface 900 is another example of presented enhancement options. Here a message board option is presented. A message board may be a monochromatic board through which messages may be presented. In some embodiments, a multicolor or full-color message board option may be presented. Another option may include a full-color video display through which not only messages may be presented, but also video, such as replays of game video, television-type advertisements, and other still image and moving video content. Once the user specified the options for the user interface 900, the NEXT button may be selected and the user interface 1000 of FIG. 1000 may be presented.

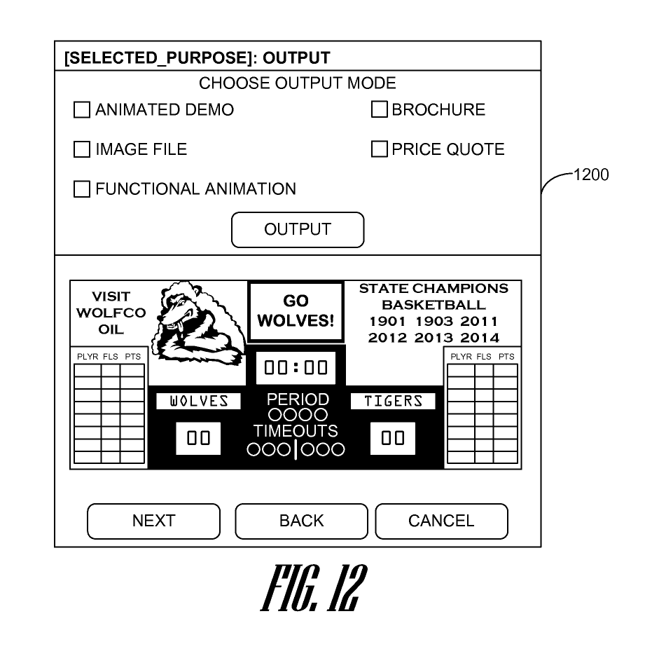

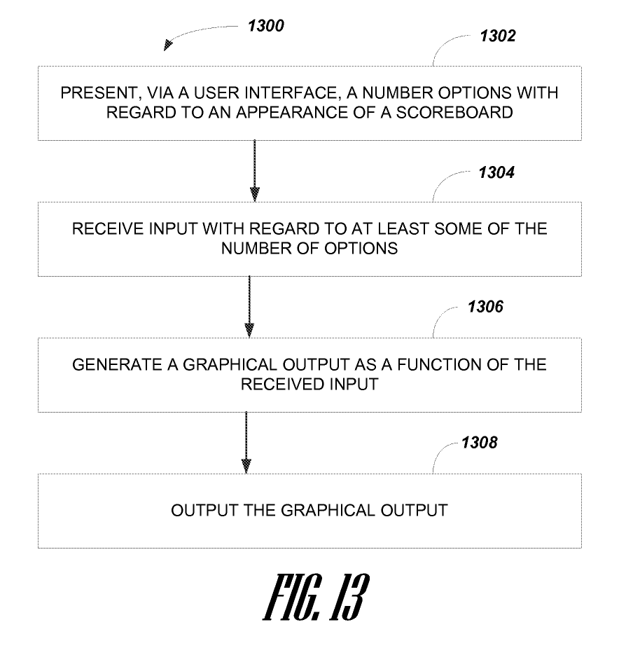

FIG. 10 is a user interface 1000 illustration, according to an example embodiment. The user interface 1000 present advertisement board options. Advertisement boards are boards upon which advertisements or other static content may be printed or otherwise affixed. For example, a team logo, a listing of sponsor names, and other content. The content to be added to the advertisement boards, when selected and added to the modeled scoreboard may be specified in the same or different user interface, such as the user interface 1100 of FIG. 11.

FIG. 11 is a user interface 1100 illustration, according to an example embodiment. The user interface 1100 provides a mechanism through which content may be uploaded for presentation on the advertisement boards added via the user interface 1000 of FIG. 10. The content uploaded may be uploaded to an application server presenting the series of user interfaces of FIG. 1 through FIG. 12 for storage thereon.

In typically web-based embodiments, as the user specifies options for the modeled scoreboard, the user options are transmitted to a webserver, which not only generates the modeled scoreboard view, but also stores the user specified options. Thus, in some embodiments, a user may return at a later date to view the modeled scoreboard again, make modifications or additions thereto, and the like. Further, the stored data may be available to a sales staff for various sales purposes, such as following up with prospects, generating scoreboard orders, and other purposes.

Further, additional and different options and enhancement options may be presented in some embodiments. For example, different portions of the scoreboard or enhancements thereto may be positioned separate from the scoreboard. Additional elements may also be added as integrated options, such as a shot clocks in basketball, play clocks in football, ribbon signage such as may be placed around a rim of an arena or stadium, and other such elements. Sound system enhancements and integrations may also be provided as options in some embodiments. An additional option may provide for a communication mechanism through which scoreboard data may be transmitted in real-time or near real-time via a network to update sports news sources on a current game state. Such scoreboard data may include score, game time, and other data that may be collected and represented via the scoreboard.

FIG. 12 is a user interface 1200 illustration, according to an example embodiment. The user interface 1200 is an example a user interface that may be presented to allow a user to select one or more output modes. Such output modes may include an animated demo that includes working scoreboard components, such as the game clock, score displays, and the like. The animated demo may be output as an animated GIF file, an animation file consumable by an animation-rendering program such as Adobe® Flash® Player, or other suitable file type. The output mode may also include a still image file, such as an SVG file consumable by a CAD program for inclusion in different renderings or mockups, a JPEG file, or other still image file type. The output may also include a brochure output that may be one or more pages and include ordering or other sales information. Some such embodiments may also allow for output of a price quote generated based on pricing information stored in association with data defining the different options the user selected.

The output in a further embodiment may include a functional scoreboard animation output. A functional scoreboard animation output may be in several different forms. Each of such forms are used to render a scoreboard that is functional for the purpose and with the options specified by the user. The functional scoreboard animation may be a small program, an app, or other functional content type that may be rendered via a display device, such as a video monitor, a video projector, or other display device. The functional scoreboard animation is also capable of receiving input indicative of game play and officiating, such as clock start and stops, scoring, fouls or penalties, timeouts, and other such game play input. The functional scoreboard animation may be output as a SWF file or other file type that is consumable by an animation rendering program, such as Adobe® Flash® Player, Microsoft® Silverlight®, or other program or application plugin.

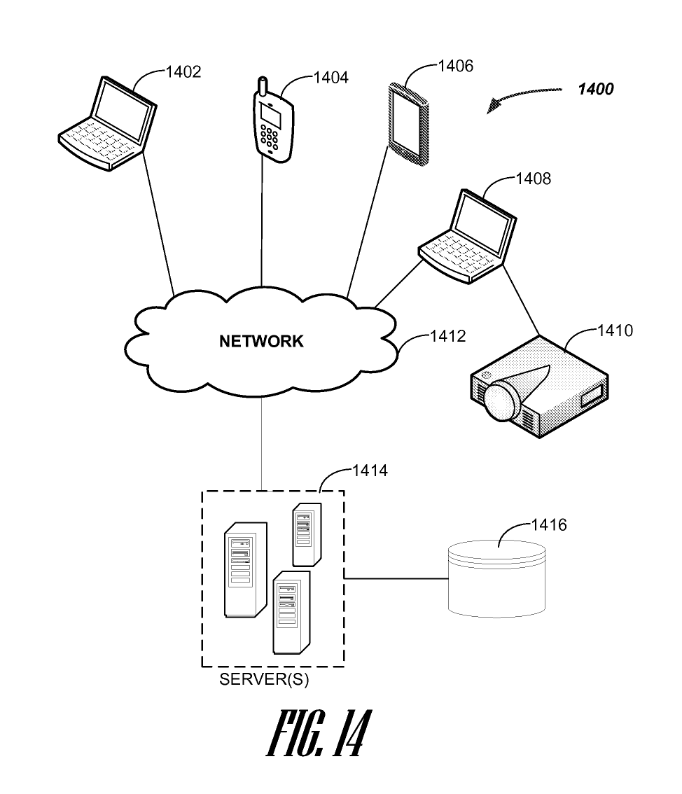

FIG. 13 is a logical block diagram of a method 1300, according to an example embodiment. The method 1300 is an example method that may be performed to request and receive user input for modeling of a scoreboard. The method 1300 includes presenting 1302, via a user interface, a number of options with regard to an appearance of a scoreboard and receiving 1304 input with regard to at least some of the number of options. The method 1300 further includes generating 1306 a graphical output as a function of the received input and outputting 1308 the graphical output. The graphical output in some embodiments is a view of a scoreboard being modeled that represents options as specified by a user.

Some embodiments of the method 1300 include receiving an input command to generate a functional scoreboard animation capable of receiving scoreboard input and rendering a view of a scoreboard. A functional scoreboard animation may be processed on a computing device through which scoreboard input is received and a scoreboard view is rendered based on the animation and the scoreboard input, the computing device outputting the scoreboard view via a graphical output device to cause the scoreboard view to be presented. The functional scoreboard output may be presented via a projector, a monitor device, via a website, and the like.

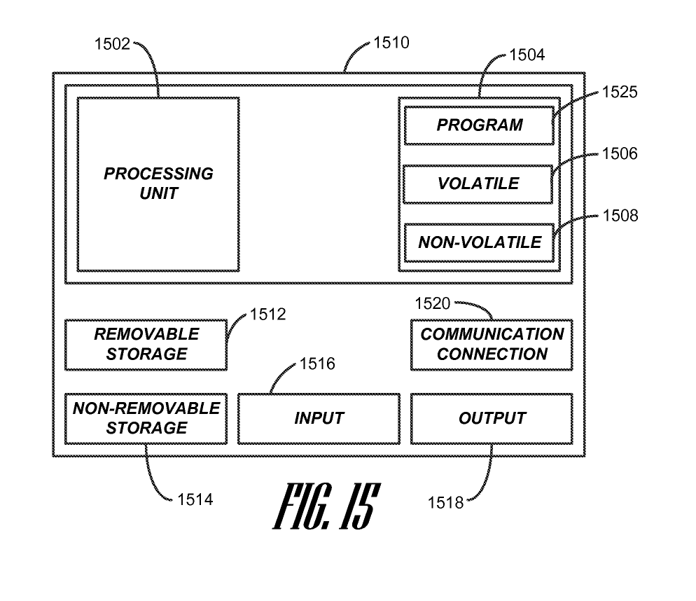

FIG. 14 is a block diagram of a system 1400, according to an example embodiment. The system 1400 is a web-hosted embodiment. The system 1400 includes one or more clients 1402, 1404, 1406 connected to a network 1412. The clients 1402, 1404, 1406 communicate via the network 1412 with one or more servers 1414, such as web servers and application servers that operate to facilitate scoreboard modeling. The one or more servers 1414 typically are also able to communicate with at least one database 1416 that stores data consumed in modeling scoreboards. Such data may include data and graphical representations of scoreboard options from which options and scoreboard renderings are presented to client 1402, 1404, 1406 users.

The clients 1402, 1404, 1406 may include a personal computer 1402, a smartphone 1404, a tablet 1406, and other client computing devices and applications.

The one or more servers 1414 may include various functional modules therein, which are typically software. The functional modules may include one or more modules to request and receive scoreboard option input. The functional modules may also include a graphical scoreboard rendering generator, a functional scoreboard animation generator, an animation generator, a brochure generator, a pricing quote generator, and other functional modules depending on the particular embodiment.

Some embodiments may also include a further client 1408. The further client 1408 is illustrated in the form of a personal computer. However, the further client 1408 may instead be in a different form, such as a tablet computer or other computing device. The further client 1408 is a computing device that consumes functional scoreboard animations as previously discussed. Scoring input is received via the further client 1408 and a scoreboard rendering may be output therefrom, such as via a projector 1410 coupled thereto. The further client 1408 may also transmit scoreboard data over the network 1412 in real-time or near real-time to update sports news sources on a current game state. Such scoreboard data may include score, game time, and other data that may be collected and represented via the scoreboard. In another embodiment, the further client 1408 may not be connected to a network and instead receive a functional scoreboard animation via a non-network mechanism, such as a from a disk, a memory stick, or other data storage device. Through such embodiments utilizing functional scoreboard content, scoreboard views may be customized for specific events of virtually any type regardless of the sport or other event type for which the scoreboard or other display is intended.

FIG. 15 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 1510, may include a processing unit 1502, memory 1504, removable storage 1512, and non-removable storage 1514. Memory 1504 may include volatile memory 1506 and non-volatile memory 1508. Computer 1510 may include—or have access to a computing environment that includes—a variety of computer-readable media, such as volatile memory 1506 and non-volatile memory 1508, removable storage 1512 and non-removable storage 1514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1510 may include or have access to a computing environment that includes input 1516, output 1518, and a communication connection 1520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a non-transitory computer-readable storage medium are executable by the processing unit 1502 of the computer 1510. A hard drive, CD-ROM, and RAM are some examples of articles including a non-transitory computer-readable storage medium. For example, a computer program 1525 capable of performing one or more methods, or portions thereof, of one or more of the methods and other embodiments illustrated and described herein.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting, via a user interface, a number of options with regard to an appearance of a scoreboard;
receiving input with regard to at least some of the number of options;
generating, through execution of instructions on a processor, a graphical output as a function of the received input, the graphical output including an image of a scoreboard based on the received input; and
outputting the graphical output.

2. The method of claim 1, wherein the number of options are presented via the user interface in an order where input received with regard to at least one option is used to determine at least other option to present, the options including a plurality of:
a plurality of purpose options;
at least one layout option with regard to each purpose option;
color options with regard to at least one scoreboard component;
text font and size options;
participant name options;
statistic panel add-on;
screen display add-on;
fixed signage add-on;
component and add-on arrangements; and
audio system add-on.

3. The method of claim 1, wherein the generated image is an animation renderable within an animation program or application plugin.

4. The method of claim 1, further comprising:
based on pricing information stored in association with each of the number of options and the input received with regard to at least some of the number of options, calculating a price for the scoreboard represented in the graphical output; and
outputting the calculated price for the scoreboard represented in the graphical output.

5. The method of claim 1, further comprising:
receiving an input command to generate an animation capable of receiving scoreboard input and rendering a view of a scoreboard.

6. The method of claim 5, wherein the graphical output includes scoreboard animation output executable on a computing device to receive game scoring input via a network and generate and transmit, via the network, renderable graphical scoreboard content.

7. The method of claim 5, wherein the graphical output includes an executable code set that is executable on a computing device to provide a functional scoreboard animation renderable via a display device communicatively coupled to the computing device on which the executable code executes.

8. The method of claim 1, wherein the user interface presents the number of options with regard to the appearance of the scoreboard via at least one web page transmitted via a network to a client computing device.

9. A non-transitory computer-readable storage medium, with instructions stored thereon, which when executed by at least one processor of at least one computing device cause the at least one computing device to:
present, via a user interface, a number of options with regard to an appearance of a scoreboard;
receive input with regard to at least some of the number of options;
generate, through execution of instructions on a processor, a graphical output as a function of the received input, the graphical output including an image of a scoreboard based on the received input; and
output the graphical output.

10. The non-transitory computer-readable storage medium of claim 9, wherein the number of options are presented via the user interface in an order where input received with regard to at least one option is used to determine at least other option to present, the options including a plurality of:
a plurality of purpose options;
at least one layout option with regard to each purpose option;
color options with regard to at least one scoreboard component;
text font and size options;
participant name options;
statistic panel add-on;
screen display add-on;
fixed signage add-on;
component and add-on arrangements; and
audio system add-on.

11. The non-transitory computer-readable storage medium of claim 9, wherein the generated image is an animation renderable within an animation program or application plugin.

12. The non-transitory computer-readable storage medium of claim 9, with further instructions stored thereon, which when executed by the at least one processor of the at least one computing device cause the at least one computing device to:
based on pricing information stored in association with each of the number of options and the input received with regard to at least some of the number of options, calculating a price for the scoreboard represented in the graphical output; and
outputting the calculated price for the scoreboard represented in the graphical output.

13. The non-transitory computer-readable storage medium of claim 9, with further instructions stored thereon, which when executed by the at least one processor of the at least one computing device cause the at least one computing device to:
receiving an input command to generate an animation capable of receiving scoreboard input and rendering a view of a scoreboard.

14. The non-transitory computer-readable storage medium of claim 13, wherein the graphical output includes scoreboard animation output executable on a computing device to receive game scoring input via a network and generate and transmit, via the network, renderable graphical scoreboard content.

15. The non-transitory computer-readable storage medium of claim 13, wherein the graphical output includes an executable code set that is executable on a computing device to provide a functional scoreboard animation renderable via a display device communicatively coupled to the computing device on which the executable code executes.

16. The non-transitory computer-readable storage medium of claim 9, wherein the user interface presents the number of options with regard to the appearance of the scoreboard via at least one web page transmitted via a network to a client computing device.

17. A system comprising:
at least one processor and at least one memory device;
a scoreboard module stored on the at least one memory device and executable by the at least one processor to:
present, via a user interface, a number of options with regard to an appearance of a scoreboard;
receive input with regard to at least some of the number of options;
generate, through execution of instructions on a processor, a graphical output as a function of the received input, the graphical output including an image of a scoreboard based on the received input; and
output the graphical output.

18. The system of claim 17, wherein the number of options are presented via the user interface in an order where input received with regard to at least one option is used to determine at least other option to present, the options including a plurality of:
a plurality of purpose options;
at least one layout option with regard to each purpose option;
color options with regard to at least one scoreboard component;
text font and size options; and
participant name options.

19. The system of claim 17, wherein the graphical output includes an executable code set that is executable on a computing device to provide a functional scoreboard animation renderable via a display device communicatively coupled to the system.

20. The system of claim 17, wherein the user interface presents the number of options with regard to the appearance of the scoreboard via at least one web page.
